(19) United States
(12) Patent Application Publication
(10) Pub. No.: US 2021/0175756 A1
(43) Pub. Date: Jun. 10, 2021

(54) POWER RECEIVING APPARATUS, POWER TRANSMITTING APPARATUS, METHOD FOR CONTROLLING SAME, AND COMPUTER-READABLE MEDIUM

(71) Applicant: CANON KABUSHIKI KAISHA, Tokyo (JP)

(72) Inventor: Wataru Tachiwa, Kanagawa (JP)

(21) Appl. No.: 17/114,243

(22) Filed: Dec. 7, 2020

(30) Foreign Application Priority Data
Dec. 10, 2019 (JP) 2019-223004

(51) Int. Cl. H02J 50/60; H02J 50/80; H02J 50/10

(52) U.S. Cl. CPC H02J 50/60; H02J 50/10; H02J 50/80

(57) ABSTRACT

A power receiving apparatus comprises a power receiving unit for wirelessly receiving power from a power transmitting apparatus, and a communication unit for communicating with the power transmitting apparatus. The power receiving apparatus determines, on the basis of foreign object existence information obtained from the power transmitting apparatus via the communication unit, one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range. The power receiving apparatus performs a first notification when the first state is determined and perform a second notification different from the first notification, when the second state is determined.

### BACKGROUND OF THE INVENTION

### Field of the Invention

The present disclosure relates to a power receiving apparatus, a power transmitting apparatus, a method for controlling the same, and a computer-readable medium.

### Description of the Related Art

Development of technology relating to wireless power transmission systems such as wireless charging systems has been carried out extensively in recent years. In wireless power transmission systems, when a foreign object enters between a power transmitting apparatus and the power receiving apparatus, this incursion needs to be detected and power transmission needs to be restricted. As defined in the standard created by the Wireless Power Consortium (WPC), a standards development group for wireless charging, foreign object detection is performed on the basis of power loss, which is the difference between the transmission power and reception power, and the Quality-factor (hereinafter, referred to as Q-factor) of resonance in a power transmitting coil. Foreign object detection is performed by comparing the power loss or Q-factor to a threshold.

Japanese Patent Laid-Open No. 2015-164368 describes detecting a foreign object on the basis of the temperature between a power transmitting apparatus and a power receiving apparatus as per WPC standard and, in the case in which a foreign object is determined to exist, notify the user via audio or a display and restrict power transmission.

However, detecting the existence of a foreign object in a binary manner using exist and not exist may lead to certain issues. For example, in the case in which the power loss value is close to the threshold used to detect the existence of a foreign object, the existence of a foreign object may be falsely determined due to an error in measuring the power loss. This issue is also found in cases other than when using the power loss value, such as cases in which the existence of a foreign object is detected on the basis of a Q-factor or temperature.

### SUMMARY OF THE INVENTION

The present disclosure provides technology for implementing notifications appropriate to a user regarding presence or absence of a foreign object.

According to one aspect of the present disclosure, there is provided a power receiving apparatus, comprising: a power receiving unit configured to wirelessly receive power from a power transmitting apparatus; a communication unit configured to communicate with the power transmitting apparatus; a determination unit configured to determine, on the basis of foreign object existence information obtained from the power transmitting apparatus via the communication unit, one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range; and a notification unit configured to perform a first notification when the first state is determined by the determination unit and perform a second notification, different from the first notification, when the second state is determined.

According to another aspect of the present disclosure, there is provided a power transmitting apparatus that wirelessly transmits power to a power receiving apparatus, comprising: a communication unit configured to communicate with the power receiving apparatus; and a transmission unit configured to transmit, to the power receiving apparatus via the communication unit, foreign object existence information that is information used by the power receiving apparatus to determine one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range.

Further features of the present disclosure will become apparent from the following description of exemplary embodiments with reference to the attached drawings.

### BRIEF DESCRIPTION OF THE DRAWINGS

FIG. 1 is a diagram illustrating an example configuration of a wireless charging system according to an embodiment.

FIG. 2 is a diagram illustrating an example configuration of a power receiving apparatus according to a first embodiment.

FIG. 3 is a diagram illustrating an example configuration of a power transmitting apparatus according to the first embodiment.

FIG. 4 is a flowchart illustrating an example of processing in the power receiving apparatus according to the first embodiment.

FIG. 5 is a flowchart illustrating an example of processing in the power transmitting apparatus according to the first embodiment.

FIGS. 6A to 6C are diagrams illustrating examples of notifications for the user performed by the power receiving apparatus according to the first embodiment.

FIG. 7A is a diagram for describing foreign object existence information generated by the power transmitting apparatus according to the first embodiment.

FIG. 7B is a diagram for describing foreign object existence information generated by a power transmitting apparatus according to a second embodiment.

FIGS. 8A and 8B are flowcharts for describing the operation of a power receiving apparatus of the second embodiment,

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

### 1. System Configuration

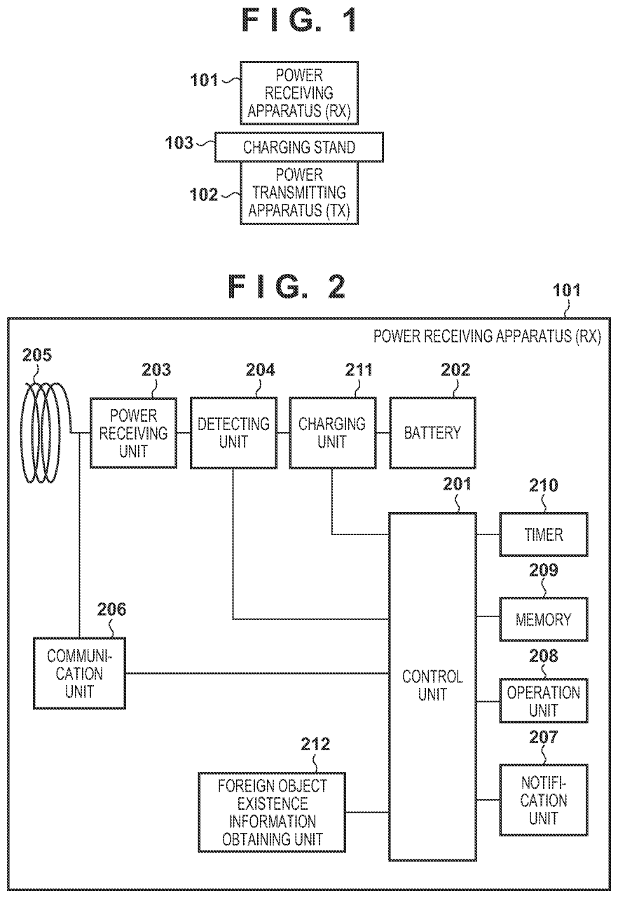

FIG. 1 illustrates an example configuration of a wireless charging system (wireless power transmission system) according to the first embodiment. The system includes a power receiving apparatus 101 and a power transmitting apparatus 102. Hereinafter, the power receiving apparatus may also be referred to as RX, and the power transmitting apparatus may also be referred to as TX. TX 102 is an electronic apparatus that wirelessly transmits power to the RX 101 placed in a charging stand 103. The RX 101 is an electronic apparatus with a built-in battery that is charged by receiving power transmitted wirelessly from the TX 102. In the example described below, the RX 101 is placed in the charging stand 103.

Note that the RX 101 and the TX 102 may have a function of executing an application other than wireless charging. An example of the RX 101 is a smartphone, and an example of the TX 102 is an accessory device for charging the smartphone. The RX 101 and the TX 102 may be storage devices, such as a hard disk or a memory device, or may be information processing devices such as a personal computer (PC). Also, the RX 101 and the TX 102, for example, may be image input devices, such as an image capture apparatus (a camera, a video camera, and the like) or a scanner, or may be an image output device, such as a printer, copying machine, or a projector. Also, the TX 102 may be a smartphone. In this case, the RX 101 may be another smartphone or a wireless earphone. Also, the RX 101 may be a vehicle. Also, the TX 102 may be a charger placed on the console or the like inside the vehicle.

Also, in the present embodiment, one RX 101 and one TX 102 are illustrated. However, other embodiments may have a configuration in which a plurality of RX 101 are charged by a single TX 102 or different individual TXs 102.

In the present system, wireless power transmission is performed using an electromagnetic induction method for wireless charging on the basis of the WPC standard. In other words, for the RX 101 and the TX 102, wireless power transmission is performed between a power receiving coil of the RX 101 and a power transmitting coil of the TX 102 to perform a wireless charge based on the WPC standard. Note that the wireless power transmission system (wireless power transmission method) used in the present system is not limited to that defined in the WPC standard, and other systems may be used, such as other electromagnetic induction systems, magnetic field resonance systems, electric field resonance systems, microwave systems, lasers, and the like. Also, in the present embodiment, the wireless charging uses wireless power transmission. However, wireless power transmission may be used for a different purpose other than for wireless charging.

The RX 101 and the TX 102 according to the present embodiment communicate to perform power transmission and reception control based on the WPC standard. The WPC standard defines a plurality of phases including a power transfer phase in which power is transmitted and phases before actual power transmission. In these phases, communication is executed to control the transmitting and receiving of power as necessary. Pre-power transmission phases include a selection phase, a ping phase, and an identification and configuration phase. Other phases may also be included. Note that hereinafter, the identification and configuration phase will be referred to as the I&C phase.

In the selection phase, the TX 102 intermittently transmits an analog ping and detects if an object is placed on the charging stand 103 (for example, if the RX 101, conductor piece, or the like is placed on the charging stand 103). The TX 102 detects at least a voltage value or a current value of a power transmitting coil when the analog ping was transmitted, determines that an object exists in the case in which the voltage value is less than a threshold or the current value is greater than a threshold, and transitions to the ping phase.

In the ping phase, the TX 102 transmits a digital ping with more power than the analog ping. The amount of power of the digital ping is sufficient enough to activate a control unit of the RX 101 placed on the charging stand 103. The RX 101 notifies the TX 102 of the amount of the received voltage. In this way, by receiving a reply from the RX 101 that received the digital ping, the TX 102 recognizes that the object detected in the selection phase is the RX 101. When the TX 102 receives a notification of the received voltage value, the process transitions to the I&C phase.

In the I&C phase, the TX 102 identifies the RX 101 and acquires device configuration information (capability information) from the RX 101. The information includes a number indicating the model and the individual of the RX 101, information indicating the maximum power required by the RX 101, information indicating the operation mode that the RX 101 supports, and the like. An example of the operation mode information is whether Extended Power Profile (hereinafter, referred to as EPP) of the WPC standard is supported. By replying to the device configuration information (capability information) via an acknowledge (ACK), the TX 102 ends the I&C phase and transitions to the power transfer phase. Note that in the case in which EPP is supported by the RX 101 and the TX 102 a different operation phase defined in the WPC standard may be transitioned to and additional communications and operations may be performed.

In the power transfer phase, control is performed to start power transmission, continue power transmission, and stop power transmission due to detection of a foreign object or a full charge. Note that hereinafter, “stop power transmission” includes in its meaning restricting power transmission to a small amount of power transmission without fully stopping power transmission.

The TX 102 and the RX 101 perform communication, for controlling the transmitting and receiving of power therebetween, that superimposes a signal on the transmission power using the same antenna (coil) as for the wireless power transmission on the basis of the WPC standard. Note that between the TX 102 and the RX 101, the range in which communication that superimposes a signal on the transmission power can be performed is substantially similar to the power-transmittal range of the TX 102.

Also, the TX 102 and the RX 101 may perform communication for power transmission and reception control using a different antenna (coil) to that used for wireless power transmission. An example of communication using a different antenna to that used for wireless power transmission is a communication system compliant with the Bluetooth (registered trademark) Low Energy standard. Other examples of communication using a different antenna to that used for wireless power transmission include IEEE 802.11 standard series wireless LAN (for example, Wi-Fi (registered trademark)) and ZigBee (registered trademark), Furthermore, communication using a different antenna (coil) to that used for wireless power transmission may be performed using another communication system, such as Near Field Communication (NFC), Radio Frequency Identifier (RFID), and the like. Communication using a different antenna (coil) to that used for wireless power transmission may be performed on a different frequency to that used for wireless power transmission.

2. Apparatus Configuration

Next, the configuration of the power receiving apparatus 101 (RX 101) and the power transmitting apparatus 102 (TX 102) according to the first embodiment will be described. Note that the configuration described below is simply one example, and a part (or all parts) of the configuration described below may be replaced by other configurations with similar functions, may be omitted, or other configurations may be added in addition to the configurations described below. Furthermore, one block described in the description below may be divided into a plurality of blocks or a plurality of blocks described in the description may be merged as a single block.

2.1 Power Receiving Apparatus Configuration

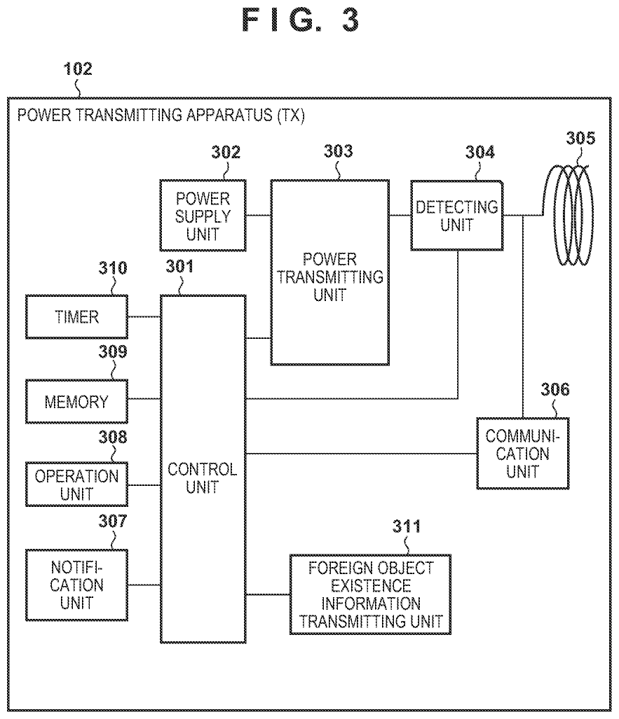

FIG. 2 is a diagram illustrating an example configuration of the RX 101 according to the first embodiment. The RX 101 includes a control unit 201, a battery 202, a power receiving unit 203, a detecting unit 204, a power receiving coil 205 a communication unit 206, a notification unit 207, an operation unit 208, memory 209, a tinier 210, a charging unit 211, and a foreign object existence information obtaining unit 212 (hereinafter, information obtaining unit 212).

The control unit 201, for example, controls the entire RX 101 by executing a control program stored in the memory 209. In other words, the control unit 201 controls the functional units illustrated in FIG. 2. Also, the control unit 201 executes control relating to power reception control of the RX 101. Furthermore, the control unit 201 may execute control for executing an application other than wireless power transmission. The control unit 201, for example, includes one or more processors, such as a central processing unit (CPU), a micro processing unit (MPU), or the like. Note that the control unit 201 may be constituted by hardware dedicated to specific processing, such as an application specific integrated circuit (ASIC), or the like. Also, the control unit 201 may include an array circuit such as a field programmable gate array (FPGA) compiled so as to execute predetermined processing. The control unit 201 causes information stored during the execution of various types of processing to be stored in the memory 209. Also, the control unit 201 is capable of measuring time using the tinier 210.

The battery 202 supplies the power to the entire RX 101 required for the control, power reception, and communication of the RX 101 by the control unit 201. Also, the battery 202 stores the power received via the power receiving coil 205.

The power receiving coil 205 generates power via electromagnetic induction utilizing electromagnetic waves radiated from the power transmitting coil of the TX 102. The power receiving unit 203 obtains the power generated at the power receiving coil 205. The power receiving unit 203 obtains alternating current power generated via electromagnetic induction at the power receiving coil 205. Also, the power receiving unit 203 converts the alternating current power to direct current or alternating current power of a predetermined frequency and outputs the power to the charging unit 211 that executes processing to charge the battery 202. In other words, the power receiving unit 203 supplies power to a load in the RX 101. Furthermore, by the power receiving unit 203 notifying the control unit 201 of the current reception power value, the reception power value at any discretionary time can be known by the control unit 201. Note that a configuration may be employed in which measuring the reception power and notifying the control unit 201 is performed by a unit other than the power receiving unit 203.

The detecting unit 204 detects the RX 101 placed on the charging stand 103 on the basis of the WPC standard. The detecting unit 204, for example, detects at least the voltage value or the current value of the power receiving coil 205 at the time when the power receiving unit 203 receives a digital ping according to the WPC standard via the power receiving coil 205. The detecting unit 204, for example, determines that the RX 101 is placed on the charging stand 103 in the case in which the voltage value is less than a predetermined voltage threshold or the current value is greater than a predetermined current threshold. 100361 The communication unit 206 performs control communication with the TX 102 based on the WPC standard such as that described above. The communication unit 206 performs communication with the TX 102 by acquiring information transmitted from the TX 102 by demodulating electromagnetic waves input from the power receiving coil 205, and by superimposing, on electromagnetic waves, information to be transmitted to the TX 102 by performing load modulation on the electromagnetic waves. In other words, communication performed by the communication unit 206 is performed by superimposition of information on electromagnetic waves transmitted from the power transmitting coil of the TX 102. Note that, as described above, the communication unit 206 may perform communication for power transmission and reception control using a different antenna to that used for wireless power transmission.

The notification unit 207 notifies the user of information via a discretionary method, such as a visual, auditory, or tactile method. The notification unit 207, for example, notifies the user of the charge state of the RX 101 or the state of the power transmission of the wireless power transmission system including the TX 102 and the RN 101 as illustrated in FIG. 1. The notification unit 207, for example, includes a liquid crystal display or LED, a speaker, a vibration generation circuit, or another type of notification device.

The operation unit 208 has a reception function of receiving operations for the RX 101 from the user. The operation unit 208, for example, includes a button or keyboard, an audio input device such as a microphone, a motion detection device such as an acceleration sensor or gyro sensor, or another type of input device. Note that the notification unit 207 and the operation unit 208 may be formed integrally as a single device such as a touch panel.

As described above, the memory 209 stores various information, such as identification information and device configuration information, a control program, and the like. Also, the memory 209 functions as a work memory for storing information as necessary during the execution of various types of processing by the control unit 201. Note that the memory 209 may store information obtained by a functional unit other than the control unit 201.

The timer 210, for example, measures time via a count up timer that measures the elapsed time from the time of activation or via a countdown timer that counts down from a set time.

The charging unit 211 charges the battery 202 via power supplied from the power receiving unit 203. Also, the charging unit 211 starts or stops charging of the battery 202 on the basis of control from the control unit 201 and adjusts the power used to charge the battery 202 on the basis of the charge state of the battery 202. When the power used by the charging unit 211 changes, the power supplied from the power receiving unit 203, i.e., the reception power at the RX 101, changes according to this change. The charging unit 211 is a load in the RX 101.

The information obtaining unit 212 obtains foreign object existence information from the TX 102 using the communication unit 206. The foreign object existence information can be represented in three levels: a foreign object exists, a foreign object possibly exists, and a foreign object does not exist. Note that the foreign object existence information may be represented in more than three levels. The information obtaining unit 212 is a program that operates on the control unit 201 that is stored in the memory 209, for example, and read out by the control unit 201 when executed. Note that the information obtaining unit 212 may be configured to operate on a CPU other than the control unit 201.

2.2 Power Transmitting Apparatus Configuration

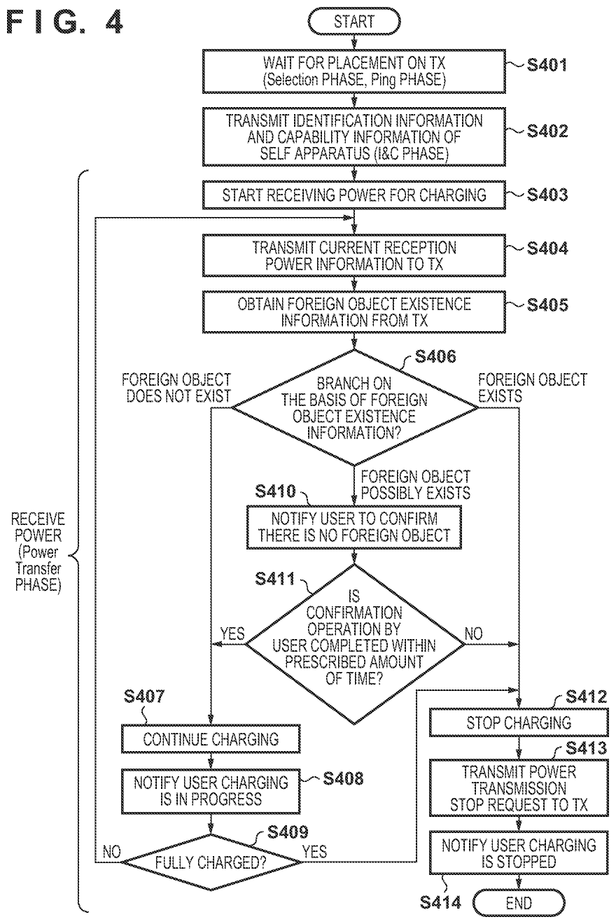

FIG. 3 is a diagram illustrating the configuration of the TX 102 according to the present embodiment. The TX 102 includes, for example, a control unit 301, power supply unit 302, a power transmitting unit 303, a detecting unit 304, a power transmitting coil 305, a communication unit 306, a notification unit 307, an operation unit 308, memory 309, a timer 310, and a foreign object existence information transmitting unit 311 (hereinafter, information transmitting unit 311).

The control unit 301, for example, controls the entire TX 102 by executing a control program stored in the memory 309. In other words, the control unit 301 controls the functional units illustrated in FIG. 3. Also, the control unit 301 executes control relating to power transmission control of the TX 102. Furthermore, the control unit 301 may execute control for executing an application other than wireless power transmission. The control unit 301, for example, includes one or more processors, such as a CPU, an MPU, or the like. Note that the control unit 301 may include hardware dedicated to specific processing such as an application specific integrated circuit (ASIC) or an array circuit such as a FPGA compiled so as to execute predetermined processing. The control unit 301 causes information stored during the execution of various types of processing to be stored in the memory 309. Also, the control unit 301 is capable of measuring time using the timer 310.

The power supply unit 302 supplies the power to the entire TX 102 required for the control, power transmission, and communication of the TX 102 by the control unit 301. The power supply unit 302, for example, is a commercial power source or a battery. Power supplied from a commercial power source is stored in the battery.

The power transmitting unit 303 converts direct current or alternating current power input from the power supply unit 302 to AC power in a frequency band used for wireless power transmission and generates electromagnetic waves for reception by the RX 101 by inputting the AC power into the power transmitting coil 305. Note that the frequency of the alternating current power generated by the power transmitting unit 303 is approximately in the hundreds of kHz range (for example, from 110 kHz to 205 kHz). The power transmitting unit 303 inputs the AC power to the power transmitting coil 305 to output, from the power transmitting coil 305, electromagnetic waves for performing power transmission to the RX 101 on the basis of instructions from the control unit 301. Also, the power transmitting unit 303 controls the intensity of the electromagnetic waves to be output by adjusting either one or both of the voltage (power transmission voltage) and the current (power transmission current) input to the power transmitting coil 305. If power transmission voltage or power transmission current is increased, the intensity of electromagnetic waves is increased, and if power transmission voltage or power transmission current is decreased, the intensity of electromagnetic waves is decreased. In addition, on the basis of an instruction from the control unit 301, the power transmitting unit 303 performs output control of the AC power to start or stop power transmission from the power transmitting coil 305. Furthermore, by the power transmitting unit 303 notifying the control unit 301 of the current transmission power value, the transmission power value at any discretionary time can be known by the control unit 301. Note that a configuration may be employed in which measuring the transmission power and notifying the control unit 301 is performed. by a unit other than the power transmitting unit 303.

The detecting unit 304 detects whether an object is placed on the charging stand 103 on the basis of the WPC standard. Specifically, the detecting unit 304 detects whether or not an object is placed on an interface surface of the charging stand 103. The detecting unit 304, for example, detects at least the voltage value or the current value of the power transmitting coil 305 at the time when the power transmitting unit 303 transmits an analog ping according to the WPC standard via the power transmitting coil 305. Note that the detecting unit 304 may detect a change in impedance. Also, the detecting unit 304, for example, is capable of determining that an object is placed on the charging stand 103 in the case in which the voltage is less than a predetermined voltage value or the current value is greater than a predetermined current value. Note that next a digital ping is transmitted via communications by the communication unit 306 to determine whether the object is a power receiving apparatus or a different object on the basis of whether or not there is a predetermined reply to the digital ping.

In other words, in the case in which the TX 102 receives the predetermined reply, the object is determined to be a power receiving apparatus and, in the other case, the object is determined to be an object other than a power receiving apparatus.

The communication unit 306 performs control communication with the RX 101 based on the WPC standard such as that described above. The communication unit 306 performs communication including modulating the electromagnetic waves output from the power transmitting coil 305 and transmitting information to the RX 101. Also, the communication unit 306 demodulates the electromagnetic waves modulated at the RX 101 outputs from the power transmitting coil 305 and obtained the information transmitted by the RX 101. In other words, communication performed by the communication unit 306 is performed by superimposition of information on electromagnetic waves transmitted from the power transmitting coil 305. Note that, as described above, the communication unit 306 may perform communication for power transmission and reception control using a different antenna to that used for wireless power transmission.

The notification unit 307 notifies the user of information via a discretionary method, such as a visual, auditory, or tactile method. The notification unit 307, for example, notifies the user of information indicating the charge state of the TX 102 or the state of the power transmission of the wireless power transmission system including the TX 102 and the RX 101 as illustrated in FIG. 1. The notification unit 307, for example, includes a liquid crystal display or LED, a speaker, a vibration generation circuit, or another type of notification device.

The operation unit 308 has a reception function of receiving operations for the TX 102 from the user. The operation unit 308, for example, includes a button or keyboard, an audio input device such as a microphone, a motion detection device such as an acceleration sensor or gyro sensor, or another type of input device. Note that the notification unit 307 and the operation unit 308 may be formed integrally as a single device such as a touch panel.

The memory 309 stores various information, a control program, and the like. Also, the memory 309 functions as a work memory for storing information as necessary during the execution of various types of processing by the control unit 301. Note that the memory 309 may store information obtained by a functional unit other than the control unit 301.

The timer 310, for example, measures time via a count up timer that measures the elapsed time from the time of activation or via a countdown timer that counts down from a set time.

The information transmitting unit 311 generates foreign object existence information and transmits the information to the RX 101 using the communication unit 306. The method for generating foreign object existence information will be described below. The information transmitting unit 311 is a program that operates on the control unit 301 that is stored in the memory 309, for example, and read out by the control unit 301 when executed. Note that the information transmitting unit 311 may be configured to operate on a CPU other than the control unit 301.

Processing Flow

Next, an example of the flow of the processing executed by the RX 101 and the TX 102 will be described.

Processing in the Power Receiving Apparatus

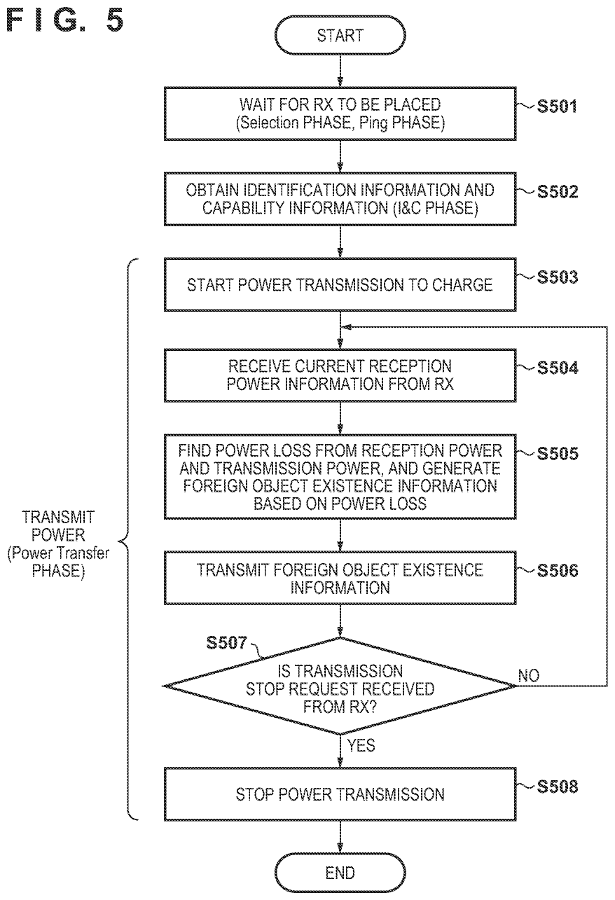

FIG. 4 is a flowchart illustrating an example of the flow of the processing executed by the RX 101. The present processing can be implemented by the control unit 201 of the RX 101 executing a program read out from the memory 209, for example. The present processing also includes processing in the information obtaining unit 212. Note that at least a part of the process of the present processing described below may be implemented by hardware. In the case of implementing processing by hardware, for example, the processing can be implemented by automatically generating, by using a predetermined compiler, a dedicated circuit that uses a gate array such as an FPGA from a program for implementing each type of processing. Also, the present processing may be executed in response to the power source of the RX 101 being turned on, in response to the RX 101 being activated by power being supplied from the battery 202 or the TX 102, or in response to the user of the RX 101 inputting a wireless charging application start instruction. Also, the present processing may be started by another trigger.

After the processing relating to transmitting and receiving power is started, the RX 101 executes processing defined in the WPC standard as a selection phase and a ping phase and waits for the RX 101 to be placed on the TX 102 (step S401). The RX 101, for example, detects that the RX 101 is placed on the charging stand 103 of the TX 102 by detecting a digital ping from the TX 102. Then, when the RX 101 detects a digital ping, a signal strength packet (received voltage value) is transmitted to the TX 102.

When the RX 101 detects that the RX 101 is placed on the charging stand 103 of the TX 102, the RX 101 executes processing defined in the WPC standard as the I&C phase and transmits identification information and device configuration information (capability information) to the TX 102 via the communication unit 206 (step S402). Note that the TX 102 may be notified of the identification information and the device configuration information (capability information) of the RX 101 by the RX 101 by a method other than communication in the I&C phase according to the WPC standard.

Next, the RX 101 start receiving power for charging from the TX 102 and starts charging the battery 202 with the charging unit 211 (step S403). After step S403, control to receive power is performed until full charge or a foreign object is detected according to the control in the power transfer phase defined in the WPC standards. In the present embodiment, the power transmission and reception control is performed based on detection of fully charging or a foreign object. However, control other than control described in the embodiments may be performed. Also, power transmission and reception control may be performed by a method other than a method according to the WPC standard.

After the RX 101 starts receiving power for charging in step S403, the RX 101 detects the current reception power value at the power receiving unit 203 and transmits reception power information to the TX 102 (step S404). Then, the RX 101 obtains foreign object existence information from the TX 102 (step S405). For example, the reception power information is transmitted as a received power packet according to the WPC standard, and the foreign object existence information is obtained by receiving the reply thereto. In this case, the foreign object existence information is included in the reply to the received power packet and transmitted by the TX 102.

Here, the foreign object existence information is the value 1, 2, or 3, where 1 indicates that a foreign object does not exist, 2 indicates that a foreign object possibly exists, at 3 indicates that a foreign object exists. Note that as described above, the combination of the numbers 1 to 3 and their meaning is not limited to the above example. The branching described below is performed on the basis of the foreign object existence information (step S406).

First, an example in which the foreign object existence information equals 1, i.e., a foreign object does not exist, in step S406 will be described. In this case, the RX 101 continues charging (step S407), and the RX 101 notifies the user via the notification unit 207 that the charging is in progress (step S408).

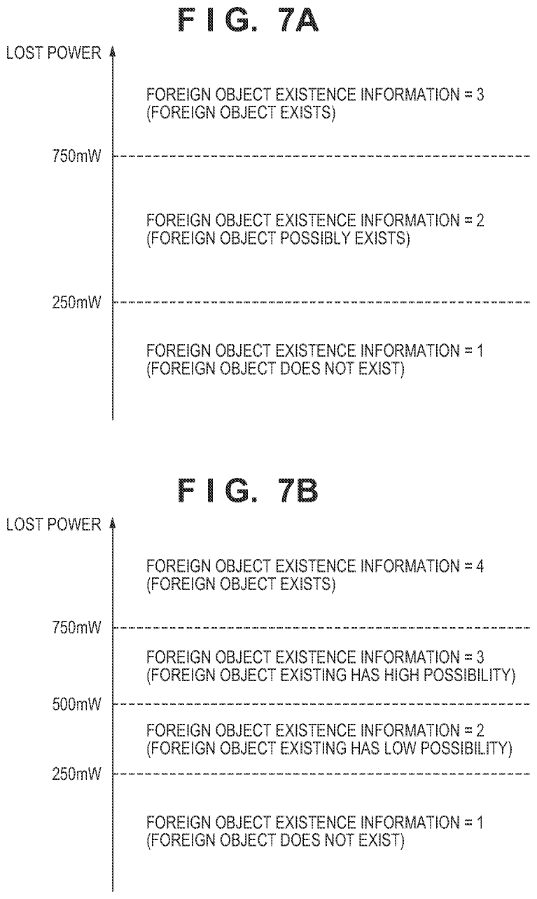

As example of the notification performed via the notification unit 207 in step S408 is illustrated in FIG. 6A. As illustrated in FIG. 6A, the electronic apparatus, which is the RX 101, includes an LED 701 that indicates whether or not the apparatus is charging and a liquid crystal display 702 for various types of display. The LED 701 and the liquid crystal display 702 constitute the notification unit that notifies the user. The RX 101 indicates that it is charging by turning on the LED 701. At this time, as illustrated in the drawing, nothing is displayed on the liquid crystal display 702. Note that a percentage of the remaining power of the battery 202 may be displayed on the liquid crystal display as indicating of the charging progress or another type of display may be performed. Also, in addition to or instead of the LED 701 turning on and the display on the liquid crystal display 702, audio or vibration may be used to perform a notification. Here, the length of continuous charging in step S407 may be a predetermined amount of time measured by the timer 210 stored in advance in the memory 209 or may be until a predetermined packet is received from the TX 102.

After charging and charging notification have been performed (step S407, step S408), the RX 101 confirms whether the battery 202 is fully charged. If the battery 202 is not fully charged (NO in step S409), the process returns to step S404 and reception power information is transmitted. If the battery 202 is fully charged (YES in step S409), charging is stopped (step S412), a power transmission stop request is transmitted to the TX 102 (step S413), the user is notified via the notification unit 207 that charging is stopped (step S414), and the process ends. Note that after the processing of step S414 ends, the RX 101 may return to step S401 and wait until it is placed on the TX 102 again.

An example of the notification of step S414 indicating that charging is stopped is illustrated in FIG. 6C. The RX 101 turns off the LED 701 that indicates whether or not charging is in progress. At this time, as illustrated in the drawing, nothing is displayed on the liquid crystal display 702. Note that characters informing that charging has stopped or another display may be displayed on the liquid crystal display 702. Also, in addition to or instead of using the LEI) 701 and the liquid crystal display 702, audio or vibration may be used to perform a notification.

Next, an example in which the foreign object existence information equals 2, i.e., a foreign object possibly exists, in step S406 will be described. In this case, the RX 101 notifies the user to confirm that there is no foreign object via the notification unit 207 (step S410). After the notification, if the user, using the operation unit 208, finishes a confirmation operation (an operation to confirm there is no foreign object) within a predetermined amount of time (YES in step S411), the process proceeds to step S408 and the RX 101 continues charging. If not (NO in step S411), the process proceeds to step S412 and the RX 101 stops charging. The process from step S408 onward and the process from step S412 onward are the same as described above.

An example of the notification unit 207 and the operation unit 208 in step S410 and step S411 is illustrated in FIG. 6B. Because charging is still being continued in step S410, the LED 701 that indicates whether or not charging is in progress is turned on. Also, on the liquid crystal display 702, a message prompting the user to confirm that there is no foreign object and a confirmation button 703 is displayed. The operation unit 208 is integrally formed with the liquid crystal display 702 as a touch panel and obtains operation information by detecting the confirmation button 703 being tapped and the user confirming that there is no foreign object. Note that, in the notification of FIG. 6B, a message may be added to prompt the user to, if there is a foreign object, remove the foreign object and then push the confirmation button 703.

Next, an example in which the foreign object existence information equals 3, i.e., a foreign object exists, in step S406 will be described. In this case, the RX 101 stops charging (step S412), transmits a power transmission stop request to the TX 102 (step S413), and notifies the user via the notification unit 207 that charging is stopped (step S414, FIG. 6C), and the process ends. Note that the user may be notified that a foreign object exists via the notification unit 207 before the process proceeds from step S406 to step S412. This notification differs from that of FIGS. 6A, 6B, and 6C. For example, a message informing the user that charging will stop due to a foreign object existing is displayed on the liquid crystal display 702.

To summarize the process from step S404 to step S414 described above, if the foreign object existence information obtained from the TX 102 indicates that a foreign object does not exist, charging is continued and the user is notified as illustrated in FIG. 6A (step S407, step S408). If the foreign object existence information indicates that a foreign object possibly exists, the user is notified as illustrated in FIG. 6B and charging is continued or stopped on the basis of the result of a confirmation operation by the user (step S410, step S411, step S407, step S412). If the foreign object existence information indicates that a foreign object exists, charging is stopped and the user is notified as illustrated in FIG. 6C (step S412 to step S414). If full charge is reached, charging is stopped (step S412 to step S414).

3.2 Processing in the Power Transmitting Apparatus

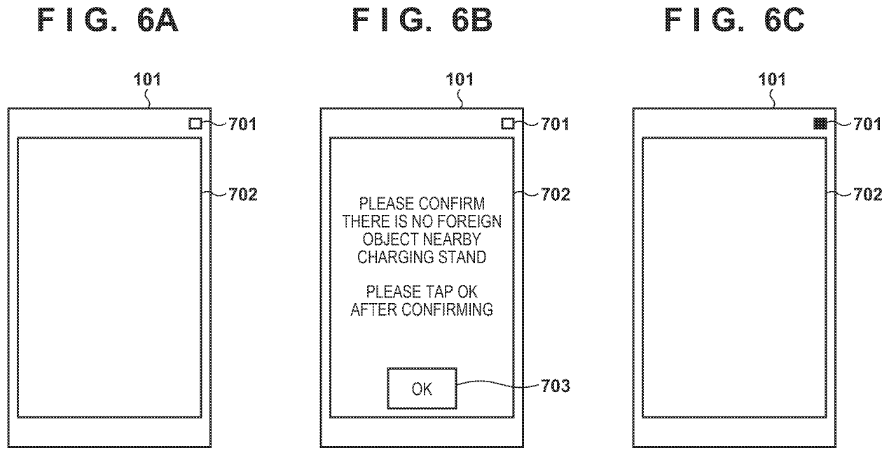

Next, an example of the flow of the processing executed by the TX 102 will be described using FIG. 5. The present processing can be implemented by the control unit 301 of the TX 102 executing a program read out from the memory 309, for example. Note that at least a part of the process described below may be implemented by hardware. In the case of implementing processing by hardware, for example, the processing can be implemented by automatically generating, by using a predetermined compiler, a dedicated circuit that uses a gate array such as an FPGA from a program for implementing each type of processing. Also, the present processing can be executed in response to the power source of the TX 102 being turned on, in response to the user of the TX 102 inputting a wireless charging application start instruction, or in response to the TX 102 connecting to a commercial power source and receiving power supply. Also, the present processing may be started by another trigger.

As illustrated in FIG. 5, the TX 102 first executes processing defined in the WPC standard as a selection phase and a ping phase and waits for the RX 101 to be placed (step S501). Specifically, the TX 102 repeats an analog ping according to the WPC standard, transmitting it intermittently, and detects whether or not an object is placed on the charging stand 103. If the TX 102 detects an object placed on the charging stand 103, the TX 102 transmits a digital ping. Also, if a predetermined reply (a signal strength packet) to the digital ping is received, then the detected object is determined to be the RX 101 and the RX 101 is determined to be placed on the charging stand 103.

When the TX 102 detects the placement of the RX 101, the TX 102 executes the I&C phase communication described above via the communication unit 306 and obtains identification information and device configuration information (capability information) from the RX 101 (step S502). Note that the TX 102 may obtain the identification information and the device configuration information (capability information) of the RX 101 from the RX 101 by a method other than I&C phase communication according to the WPC standard.

Next, the TX 102 starts power transmission to charge the RX 101 (step S503). After step S503, control to transmit power is performed until full charge or a foreign object is detected according to the control in the power transfer phase defined in the WPC standards. Note that control other than the control described in the present embodiment may be performed. Also, control may be performed by a method other than a method according to the WPC standard.

After power transmission for charging is started in step S503, the TX 102 receives the current reception power information from the RX 101 (step S504). Furthermore, the current power loss is found from the difference between the current reception power value included in the reception power information and the current transmission power value of the TX 102 detected at the power transmitting unit 303 and the three level foreign object existence information is generated based on the power loss (step S505). The TX 102 transmits the foreign object existence information generated as described above to the RX 101 (step S506). Note that in step S504, for example, the reception power information can be obtained by receiving a received power packet according to the WPC standard. in step S506, for example, the TX 102 transmits a reply to the received power packet including the foreign object existence information.

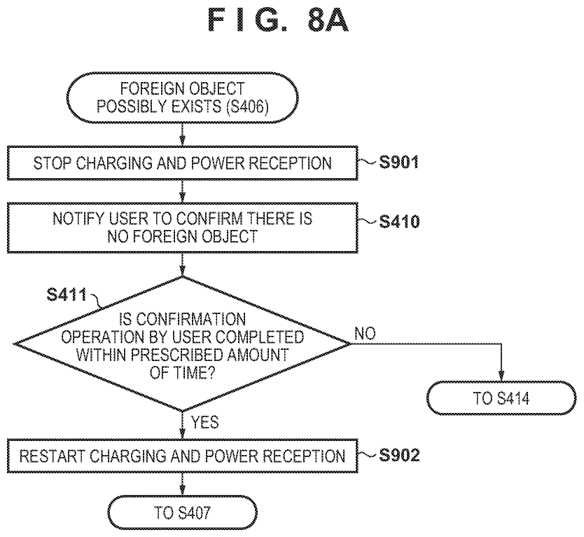

A method for generating the foreign object existence information from the power loss will be described using FIG. 7A. In the case in which a foreign object exists between the power transmitting coil 305 of the TX 102 and the power receiving coil 205 of the RX 101, power is consumed and power loss is increased, in the case in which the power loss is a sufficiently large value, for example 750 mW or greater, the foreign object existence information is 3 (indicating a state (a first state) in which a foreign object exists in the power-transmittal range of the TX 102). In the case in which the power loss is a sufficiently small value, for example 250 mW or less, the foreign object existence information is 1 (indicating a state (a third state) in which a foreign object does not exist in the power-transmittal range). Also, in the case in which the power loss is between 250 mW and 750 mW, the foreign object existence information is 2 (indicating a state (a second state) in which a foreign object possibly exists in the power-transmittal range). This means that it is difficult to determine the foreign object's existence, i.e., whether or not a foreign object exists due to a measurement error of the power or the like.

Note that the values for the foreign object existence information indicating the existence state of the foreign object are set as 1, 2, and 3 according to the meaning. However, as long as the states can be allocated to at least three distinct levels, another allocation method may be used. Also, the thresholds of 250 mW and 750 mW for power illustrated in FIG. 7A are examples, and other thresholds may be used. These thresholds may be stored in advance in the memory 209 of the TX 102 or may be set dynamically according to the amount of transmission power. In the case in which the thresholds are set according to the amount of transmission power, the result of processing of a calibration phase defined in the WPC standard may be used. Also, the value of power loss as is may be used as the foreign object existence information. In this case, thresholds of 250 mW and 750 mW may be stored on the RX 101 and three distinct levels may be used. In this case, as with the processing in step S505, the RX 101 may determine the foreign object existence state from among the first state to the third. state described above on the basis of the foreign object existence information (power loss value).

Also, the foreign object existence information may be generated on the basis of a value other than the power loss, as long as this value changes depending on whether or not a foreign object exists. For example, the foreign object existence information may be generated on the basis of the Q-factor of resonance in the power transmitting coil 305, defined in the WPC standard. Note that in the case in which the foreign object existence information is generated on the basis of the Q-factor, the RX 101 may obtain the foreign object existence information via a reply packet to a FOD status packet according to the WPC standard. Also, the foreign Object existence information may be generated on the basis of the temperature between the TX 102 and the RX 101. Furthermore, a foreign object existence probability from 0 to 100% obtained from combining one or more values that change depending on whether or not a foreign object exists may be used as the foreign object existence information. In this case, the three levels can be defined as, for example, 80% or greater indicating that a foreign object exists, 20% or less indicating that a foreign object does not exist, and between 20% and 80% indicating that a foreign object possibly exists. Also, information including at least one from among: information for specifying the power loss, information for specifying the Q-factor, and information for specifying the temperature may be used as the foreign object existence information. In this case, for example, the foreign object existence information includes at least one of the value for power loss, the Q-factor, or the value for temperature described above.

Returning to FIG. 5, after the foreign object existence information generated as described above is transmitted to the RX 101 (step S506), the TX 102 determines whether or not a power transmission stop request has been received from the RX 101 (step S507). If a power transmission stop request has been received from the RX 101 (YES in step S507), power transmission is stopped and the process is ended (step S508). If this is not the case (NO in Step S507), power transmission is continued and the process returns to step S504. Note that in the case in which the foreign object existence information is 3, i.e., a foreign object exists, in step S505, the TX 102 may perform control to voluntarily stop transmitting power without waiting to receive a power transmission stop request from the RX 101. Also, after the processing of step S508 ends, the TX 102 may return to step S501 and wait until the RX 101 is placed again.

3.3 System Operation

The operation of the system including the RX 101 and the TX 102 described using FIGS. 4 and 5 will be described using an example.

First, the case when no foreign object exists and the power loss detected by the TX 102 is 250 mW or less will be described. In this case, information that the foreign object existence information is 1, i.e., a foreign object does not exist, is generated and transmitted in step S505 and step S506 of the TX 102. Then, at the branch at step S406 of the RX 101, the process proceeds to step S407 and charging is performed and the notification unit 207 is put in the state illustrated in FIG. 6A indicating that charging is in progress. In other words, charging is automatically performed without user confirmation of a foreign object or user operation.

Next, the case when a foreign object exists partially on the charging stand 103 or the like and the power loss detected by the TX 102 is between 250 mW and 750 mW will be described. In this case, information that the foreign object existence information is 2, i.e., a foreign object possibly exists, is generated and transmitted in step S505 and step S506 of the TX 102. Then, from the branch at step S406 of the RX 101, the process proceeds to step S411 and the notification unit 207 performs a notification as illustrated in FIG. 6B. The user receives the notification and continues or stops charging on the basis of the result of confirmation by the user.

Next, the case when a foreign object does not exist but the power loss detected by the TX 102 is between 250 mW and 750 mW due to circuit loss or error will be described. In this case, information that the foreign object existence information is 2, i.e., a foreign object possibly exists, is generated and transmitted in step S505 and step S506 of the TX 102. Then, from the branch at step S406 of the RX 101, the process proceeds to step S411 and the notification unit 207 performs a notification as illustrated in FIG. 6B. The user receives the notification and continues or stops charging on the basis of the result of confirmation by the user.

Next, the case when a foreign object exists and the power loss detected by the TX 102 is 750 mW or greater will be described. In this case, information that the foreign object existence information is 3, i.e., a foreign object exist, is generated and transmitted in step S505 and step S506 of the TX 102. Then, at the branch at step S406 of the RX 101, the process proceeds to step S412 and charging is stopped and the notification unit 207 is put in the state illustrated in FIG. 6C indicating that charging is stopped. In other words, charging is automatically stopped without user confirmation of a foreign object or user operation.

As described above, according to the power receiving apparatus of the first embodiment, when it is difficult to determine the existence of a foreign object in a binary manner using exist and not exist, the user can be notified and made to confirm that there is no foreign object. In this way, uses operation can be more appropriately prompted.

Also, in the first embodiment, when a foreign object does not exist, the power receiving apparatus performs a notification informing of this. However, this notification can be omitted. In other words, when a foreign object does not exist, the user does not need to perform a task such as removing a foreign object. Thus, the notification can be omitted. This reduces power consumption and is effective in decreasing charge time.

### Second Embodiment

The configuration of a wireless charging system (wireless power transmission system), the configuration of the RX 101, and the configuration of the TX 102 according to the second embodiment are similar to that of the first embodiment (FIGS. 1 to 3). The difference between the first embodiment and the second embodiment is that the processing in the RX 101 when the foreign object existence information is determined as “a foreign object possibly exists” is different.

In the first embodiment, in the case in which the foreign object existence information is 2, i.e., a foreign object possibly exists, the TX 102 continues power transmission, but stops power transmission on the basis of a request from the RX 101 if confirmation by the user has not been performed on the RX 101 for a predetermined amount of time. In other words, control is performed to continue power transmission while waiting for user confirmation.

In the second embodiment, in the case in which the foreign object existence information is 2, i.e., a foreign object possibly exists, the TX 102 stops power transmission, but starts power transmission on the basis of a request from the RX 101 if confirmation by the user is performed on the RX 101 within a predetermined amount of time. In other words, control is performed to stop power transmission while waiting for user confirmation. In this way, when a foreign object actually exists, power transmission to the foreign object can be prevented while waiting for user confirmation.

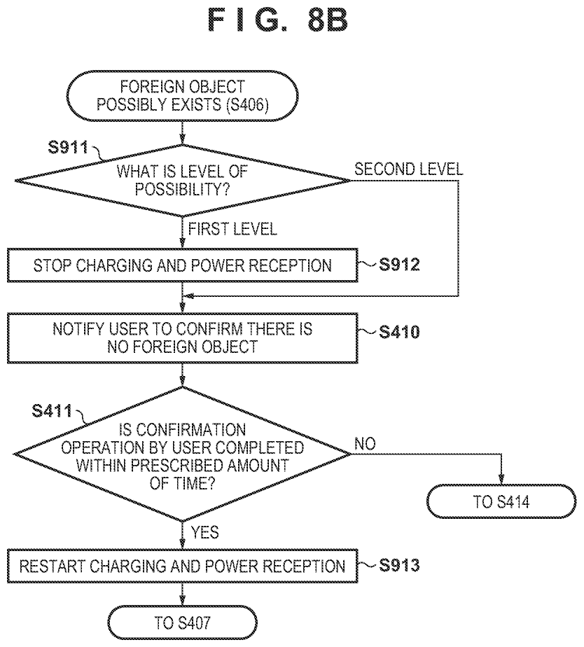

FIG. 5A is a flowchart for describing the operation of the RX 101 of the second embodiment. FIG. 8A illustrates a process that replaces steps S410 to S411 of FIG. 4. In the case in which the second state (a foreign object possibly exists) is determined in step S406, the RX 101 stops charging and power reception (step S901). This process is similar to that of step S412 and step S413. Then, the RX 101 instructs the user to confirm that there is no foreign object (step S410). In the second embodiment, when charging is stopped, the display state is as in FIG. 6B with the LED 701 turned off A display informing that charging and power transmission are stopped may be displayed on the liquid crystal display 702. Then, if confirmation from the user has not been obtained within a predetermined amount of time (NC) in step S411), the process proceeds to step S411. If confirmation from the user is obtained within a predetermined amount of time (YES in step S411), the RX 101 restarts receiving power from the TX 102 and charging the battery 202 (step S902) and the process proceeds to step S407.

Also, the state of a foreign object possibly existing may be split into at least a first level and a second level in order of the highest possibility that a foreign object exists, and the process may be different for when the first level is determined and for when the second level is determined.

For example, the foreign object existence information generated in the TX 102 may have four levels as illustrated in FIG. 7B, and, for the RX 101, in the case in which a foreign object existing has a low possibility, power transmission may be continued and the RX 101 may wait for user confirmation and, in the case in which a foreign object existing has a high possibility, power transmission may be stopped and the RX 101 may wait for user confirmation. In this way, charging is given priority and finished quickly if a foreign object does not exist only when there is a low possibility for a foreign object existing.

The processing in this case is illustrated in FIG. 8B. FIG. 8B illustrates a process that replaces steps S410 to S411 of FIG. 4. In the case in which the second state (a foreign object possibly exists) is determined in step S406, the RX 101 further determines whether the level of possibility is the first level (the foreign object existence information is 3) or the second level (the foreign object existence information is 2) (step S911). In the case in which the first level is determined, the RX 101 stops charging and power reception (step S912). This process is similar to that of step S412 and step S413. In the case in which the second level is determined, the RX 101 skips step S912 and continues receiving power.

Then, the RX 101 instructs the user to confirm that there is no foreign object (step S410). In the case in which the first level is determined, as charging is stopped, the display state is as in FIG. 6B with the LED 701 turned off. Here, a display informing that charging and power transmission are stopped may be displayed on the liquid crystal display 702. In the case in which the second level is determined, as charging is continued, the display state is as in FIG. 6B. Then, if confirmation from the user has not been obtained within a predetermined amount of time (NO in step S411), the process proceeds to step S414. If confirmation from the user is obtained within a predetermined amount of time (YES in step S411), the RX 101 restarts receiving power from the TX 102 and charging the battery 202 (step S913) and the process proceeds to step S407. Note that in the case in which the second level is determined, as power reception and charging is continued, step S913 is a NOP.

As described above, the state of “a foreign object possibly exists” may be further split and power reception, charging, and notification may be controlled accordingly. This allows very detailed power reception control and user notification to be performed.

In other words, according to the embodiments described above, the user can be appropriately notified regarding the existence of a foreign object.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Note that at least a part of the processing illustrated in the flowcharts of FIGS. 4, 5, 5A, and 5B may be implemented by hardware. In the case of implementing processing by hardware, for example, using a predetermined compiler, the processing can be implemented by automatically generating a dedicated circuit on an FPGA (Field Programmable Gate Array) from a program for implementing the processing. In addition, similarly to an FPGA, a gate array circuit may be formed and implemented as hardware.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions,

This application claims the benefit of Japanese Patent Application No. 2019-223001, filed Dec. 10, 2019 which is hereby incorporated by reference herein in its entirely.

What is claimed is:

1. A power receiving apparatus, comprising:
a power receiving unit configured to wirelessly receive power from a power transmitting apparatus;
a communication unit configured to communicate with the power transmitting apparatus;
a determination unit configured to determine, on the basis of foreign object existence information obtained from the power transmitting apparatus via the communication unit, one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range; and
a notification unit configured to perform a first notification when the first state is determined by the determination unit and perform a second notification, different from the first notification, when the second state is determined.

2. The apparatus according to claim 1, wherein
when the first state is determined, a request to stop power transmission is wirelessly transmitted from the communication unit to the power transmitting apparatus; and
the first notification indicates that power reception is stopped and/or a foreign object exists.

3. The apparatus according to claim 1, wherein the second notification prompts a user to confirm whether a foreign object exists.

4. The apparatus according to claim 3, wherein
after the second notification has been performed, if a user operation has not been performed confirming that a foreign object does not exist within a predetermined amount of time, a request to stop wireless power transmission is transmitted from the communication unit to the power transmitting apparatus.

5. The apparatus according to claim 3, wherein after the second notification has been performed, if a user operation has been performed confirming that a foreign object does not exist within a predetermined amount of time, a request to start wireless power transmission is transmitted from the communication unit to the power transmitting apparatus.

6. The apparatus according to claim 1, wherein
the notification unit is configured to perform a third notification when the third state is determined; and
the third notification indicates that a foreign object does not exist and/or that power is being received.

7. The apparatus according to claim 1, wherein
the foreign object existence information indicates one state from the at least three states; and
the determination unit is configured to receive the foreign object existence information from the power transmitting apparatus via the communication unit and determine an existence state of a foreign object.

8. The apparatus according to claim 7, wherein the foreign object existence information is information generated based on at least one of: power loss, Quality-factor, or temperature.

9. The apparatus according to claim 1, wherein
the foreign object existence information includes at least one of: information for specifying power loss, information for specifying Quality-factor, or information for specifying temperature; and
the determination unit is configured to determine, on the basis of the foreign object existence information received from the power transmitting apparatus via the communication unit, one state from the at least three states.

10. The apparatus according to claim 1, further comprising
a power transmission control unit configured to transmit a request to stop wireless power transmission to the power transmitting apparatus via the communication unit when the second state is determined by the determination unit.

11. The apparatus according to claim 10, wherein
the second state is split into at least a first level and a second level in order of highest possibility that a foreign object exists; and
the power transmission control unit is configured to stop power transmission by the power transmitting apparatus when the first level is determined by the determination unit and to not stop power transmission by the power transmitting apparatus when the second level is determined.

12. The apparatus according to claim 1, wherein
determination unit is configured to obtain the foreign object existence information via a reply to a received power packet according to WPC standard or a reply to a FOD status packet according to WPC standard.

13. A power transmitting apparatus that wirelessly transmits power to a power receiving apparatus, comprising:
a communication unit configured to communicate with the power receiving apparatus; and
a transmission unit configured to transmit, to the power receiving apparatus via the communication unit, foreign object existence information that is information used by the power receiving apparatus to determine one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range.

14. The apparatus according to claim 13, further comprising a determination unit configured to determine the first state, the second state, or the third state on the basis of at least one of: power loss, Quality-factor, or temperature, and
a generation unit configured to generate the foreign object existence information indicating the state determined by the determination unit.

15. The apparatus according to claim 13, wherein the foreign object existence information includes at least one of:
information for specifying power loss, information for specifying Quality-factor, or information for specifying temperature.

16. The apparatus according to claim 13, wherein
the transmission unit is configured to transmit the foreign object existence information via a reply to a received power packet according to WPC standard or a reply to a FOD status packet according to WPC standard.

17. A method for controlling a power receiving apparatus including a power receiving unit configured to wirelessly receive power from a power transmitting apparatus and a communication unit configured to communicate with the power transmitting apparatus, comprising:
determining, on the basis of foreign object existence information obtained from the power transmitting apparatus via the communication unit, one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range; and
performing a first notification when the first state is determined and performing a second notification, different from the first notification, when the second state is determined.

18. A method for controlling a power transmitting apparatus including a transmission unit configured to wirelessly transmit power to a power receiving apparatus and a communication unit configured to communicate with the power receiving apparatus, comprising:
transmitting, to the power receiving apparatus via the communication unit, foreign object existence information that is information used by the power receiving apparatus to determine one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range.

19. A non-transitory computer-readable medium storing a program which causes a computer to execute a method for controlling a power receiving apparatus including a power receiving unit configured to wirelessly receive power from a power transmitting apparatus and a communication unit configured to communicate with the power transmitting apparatus, wherein the method for controlling includes
determining, on the basis of foreign object existence information obtained from the power transmitting apparatus via the communication unit, one state from at least three states including a first state in which a foreign object exists in a power-transmittal range of the power transmitting apparatus, a second. state in which a foreign object possibly exists in the power-transmittal range, and a third state in which a foreign object does not exist in the power-transmittal range; and
performing a first notification when the first state is determined and performing a second notification, different from the first notification, when the second state is determined.

20. A non-transitory computer-readable medium storing a program which causes a computer to execute a method for controlling a power transmitting apparatus including a transmission unit configured to wirelessly transmit power to a power receiving apparatus and a communication unit configured to communicate with the power receiving apparatus, wherein
the method for controlling includes transmitting, to the power receiving apparatus via the communication unit, foreign object existence information that is information used by the power receiving apparatus to determine one state from at least three states including a first state in which a foreign object exists in a power-transmittal range of the power transmitting apparatus, a second state in which a foreign object possibly exists in the power-transmittal range, and a third state in which a foreign object does not exist in the power-transmittal range.
